(19) United States
(12) Patent Application Publication
(10) Pub. No.: US 2012/0030544 A1
(43) Pub. Date: Feb. 2, 2012

(54) Accessing Memory for Data Decoding

(76) Inventor: Timothy Perrin Fisher-Jeffes, Cambridge, MA (US)

(21) Appl. No.: 12/843,894

(22) Filed: Jul. 27, 2010

(51) Int. Cl. G06F 11/00

(52) U.S. Cl. 714/772; 714/E11.002

(57) ABSTRACT

A method comprises receiving a sequence of unique memory addresses associated with concatenated, convolutionally encoded data elements. The method also comprises identifying each of the unique memory addresses as being included in one group of a plurality of address groups. Each address group substantially includes an equivalent number of unique addresses. The method also comprises, in parallel, accessing at least one memory address associated with each group of the plurality of address groups to operate upon the respective concatenated, convolutionally encoded data elements associated with each of the unique memory addresses being accessed.

### BACKGROUND

This description relates to a system and method for decoding data such as data encoded with convolutional codes.

For information transmission and reception, various types of error correcting codes have been developed along with corresponding decoding algorithms. To provide strong error correcting capabilities, such codes may call for cumbersome and complex decoders for approaching the data transmission theoretical limits such as channel capacity (referred to as the Shannon limit after Claude Shannon, who introduced the notion in 1948). To reduce complexity, in one technique, multiple relatively straight forward codes, each of which may not individually provide significant error correcting capabilities, are concatenated to produce a longer code that can provide enhanced error correcting capabilities.

### SUMMARY

In general, in one aspect, a method of accessing a memory for data decoding comprises receiving a sequence of unique memory addresses associated with concatenated, convolutionally encoded data elements. The method also comprises identifying each of the unique memory addresses as being included in one group of a plurality of address groups. Each address group substantially includes an equivalent number of unique addresses. The method also comprises, in parallel, accessing at least one memory address associated with each group of the plurality of address groups to operate upon the respective concatenated, convolutionally encoded data elements associated with each of the unique memory addresses being accessed.

Implementations may include one or more of the following features. Operating upon the respective concatenated, convolutionally encoded data elements may include reading the data elements from the unique memory addresses being accessed, or writing the data elements to the appropriate unique memory addresses. One group of the plurality of address groups includes even numbered addresses, and, one group may include odd numbered addresses. The method may also comprise ordering the data elements based upon the address group identifications of the corresponding unique memory addresses. The received unique memory addresses associated with the concatenated, convolutionally encoded data elements may be interleaved. Receiving unique memory addresses may include entering one unique memory address into a first buffer and entering another unique memory address into a second buffer. The first buffer and second buffer may have equivalent lengths. The buffers may be configured to store various numbers of addresses such as sixteen unique memory addresses.

In another aspect, a computing device comprises a decoder for receiving a sequence of unique memory addresses associated with concatenated, convolutionally encoded data elements. The decoder is configured to identify each of the unique memory addresses as being included in one group of a plurality of address groups. Each address group substantially includes an equivalent number of unique addresses. The decoder is further configured to, in parallel, access at least one memory address associated with each group of the plurality of address groups to operate upon the respective concatenated, convolutionally encoded data elements associated with each of the unique memory addresses being accessed.

Implementations may include one or more of the following features. To operate upon the respective concatenated, convolutionally encoded data elements, the decoder may be configured to read the data elements from the unique memory addresses being accessed, or, write the data elements to the appropriate unique memory addresses. One group of the plurality of address groups may include even numbered addresses, and, another group may include odd numbered addresses. The decoder may be further configured to order the data elements based upon address group identifications of the corresponding unique memory addresses. The received unique memory addresses associated with the concatenated, convolutionally encoded data elements may be interleaved. The decoder may include a first buffer for entering one unique memory address and a second buffer for entering another unique memory address. The first buffer and second buffer may have equivalent lengths. The buffers may be configured to store various numbers of addresses such as sixteen unique memory addresses.

In still another aspect, a computer program product tangibly embodied in an information carrier and comprises instructions that when executed by a processor perform a method comprising, receiving a sequence of unique memory addresses associated with concatenated, convolutionally encoded data elements. The method also comprises identifying each of the unique memory addresses as being included in one group of a plurality of address groups. Each address group substantially includes an equivalent number of unique addresses. The method also comprises, in parallel, accessing at least one memory address associated with each group of the plurality of address groups to operate upon the respective concatenated, convolutionally encoded data elements associated with each of the unique memory addresses being accessed.

Implementations may include one or more of the following features. Operating upon the respective concatenated, convolutionally encoded data elements may include reading the data elements from the unique memory addresses being accessed, or writing the data elements to the appropriate unique memory addresses. One group of the plurality of address groups includes even numbered addresses, and, one group may include odd numbered addresses. The method may also comprise ordering the data elements based upon address group identifications of the corresponding unique memory addresses. The received unique memory addresses associated with the concatenated, convolutionally encoded data elements may be interleaved. Receiving unique memory addresses may include entering one unique memory address into a first buffer and entering another unique memory address into a second buffer. The first buffer and second buffer may have equivalent lengths. The buffers may be configured to store various numbers of addresses such as sixteen unique memory addresses.

These and other aspects and features and various combinations of them may be expressed as methods, apparatus, systems, means for performing functions, program products, and in other ways.

Other features and advantages will be apparent from the description in the claims.

### DESCRIPTION OF DRAWINGS

FIG. 1 is a block diagram of a portion of an encoding system.

FIG. 2 is a block diagram of a portion of a decoding system.

FIGS. 3 and 4 are block diagrams of a portion of a memory access manager.

FIG. 5 is a chart that represents throughput performance.

FIG. 6 is a flowchart of operations of a memory access manager.

### DETAILED DESCRIPTION

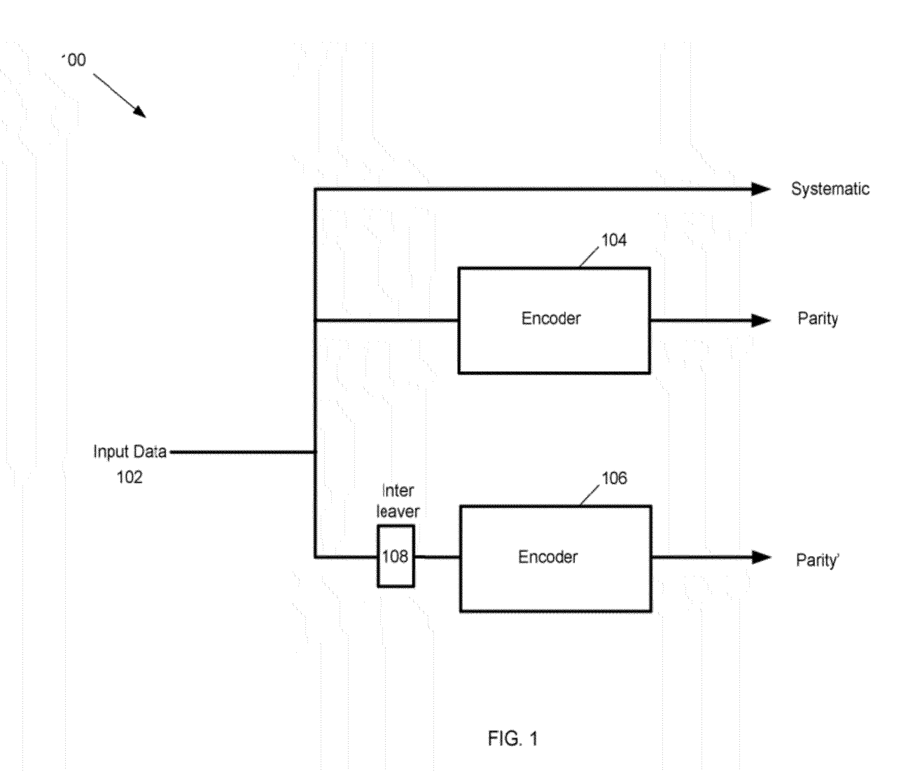

Referring to FIG. 1, an exemplary encoding system 100 may employ one or more encoding techniques to prepare data (or multiple data sets) for transmission over a communication channel. Implementing such techniques provides several advantages such as correcting errors at a receiver. In this particular arrangement, the encoding system 100 implements a turbo code architecture in which two convolutional codes are used to encode input data 102 by producing three output bits for each bit included in the input data. As illustrated, each input bit is also provided as an output (referred to as being in systematic form) for transmission. In general, a turbo code is formed from the parallel concatenation of two codes separated by an interleaver. As such, two encoders 104, 106 are implemented and operate in similar manners to apply one or more codes (e.g., a recursive systematic convolutional (RSC) code) to the input data 102. To separate the codes applied by the encoders 104 and 106, an interleaver 108 processes the input data 102 prior to being provided to the encoder 106. As such, the interleaved version of the input data 102 causes the encoder 106 to output data that is quite different from the data output from the encoder 104. As such, two separate codes are produced that may be combined in a parallel manner. Such combinations lend to allowing portions of the combined code to be separately decoded by less complex decoders. Further, the performance of each decoder may be improved by exchanging information separately extracted from each of the decoders. Further, due to the interleaver 108 providing a different input data to the encoder 106 (compared to the input data of encoder 104), the output of the encoder is different (e.g., uncorrelated) from the output of the encoder 104. As such, more information regarding error detection and correction may be provided during decoding of transmitted data.

In general, the interleaver 108 can be considered as rearranging the order of data elements (e.g., bits) of the input data 102 in a pseudo-random, albeit a deterministic order. To provide such functionality, the interleaver 108 may implement one or more interleaver techniques such as row-column, helical, odd-even, pseudo-random, etc. Along with the systematic output data, each of the encoders 104 and 106 outputs parity data (identified as Parity and Parity') that is also transmitted for error detection and correction.

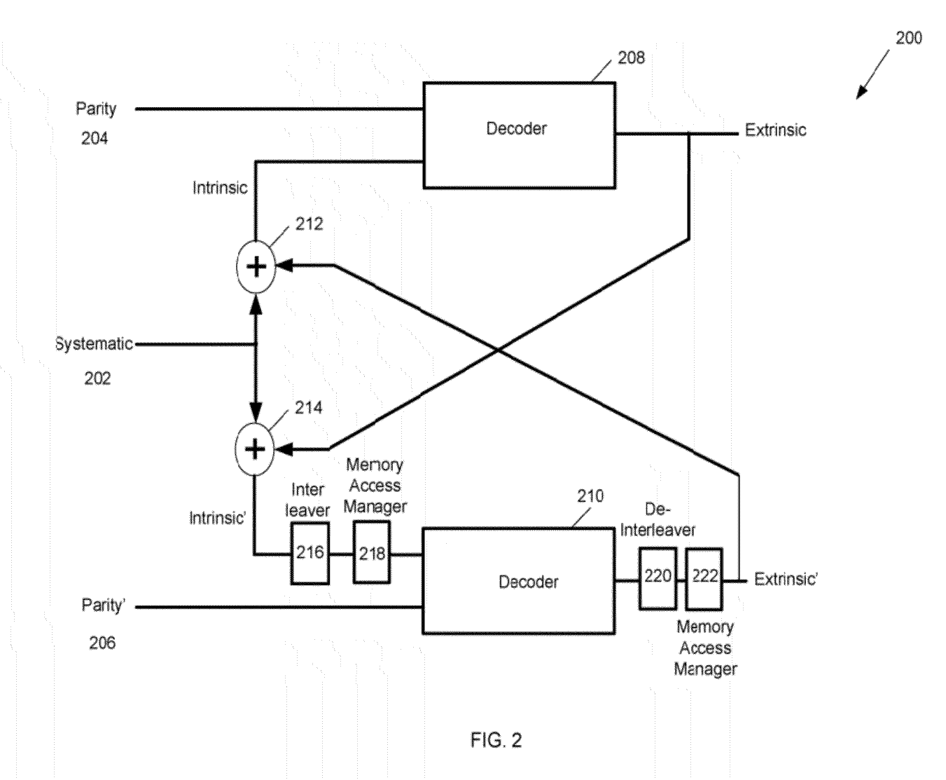

Referring to FIG. 2, a block diagram of an exemplary decoding system 200 is illustrated that is capable of decoding data that has been encoded by one or more techniques. For example, encoded data provided by the encoding system 100 (shown in FIG. 1) may be decoded by the decoding system 200. In such a scenario, the three data sets provided by the encoding system 100 are received by the decoding system 200. In particular, along with systematic data (identified as Systematic 202), both sets of parity data (e.g., Parity 204 and Parity′ 206) are received and provide controlled redundancy to the transmitted data such that the decoding system 200 can detect the presence of transmission errors, and where possible, correct the errors.

Various types of decoding techniques may be used to reveal the transmitted encoded data. For example, in some arrangements a receiver associated with a decoding system may render a determination about a received data bit (e.g., represents a binary value of 0 or 1). Once determined, the data bit may be provided to the decoding system for further processing. For such a technique some data bits are typically determined with greater certainty than others, however, information used to make the determination may not be provided and exploited by the decoding system. In some arrangements, the decoding system may be provided a numerical value (referred to as a “soft” input) rather than a “hard” determination from the receiver. Provided this input, the decoding system may output (for each data bit) an estimate that reflects the probability associated with the transmitted data bit (e.g., probability of binary value 0 or 1).

In this particular arrangement, the decoding system 200 includes two decoders 208 and 210 that may use a decoding technique such as Viterbi decoding (or another type of technique). In general, the decoding system 200 uses a recursive decoding technique such that the decoder 208 provides an extrinsic output (labeled “Extrinsic”) that can be considered as an error estimate of the systematic input 202. Similarly, the decoder 210 provides extrinsic output (labeled “Extrinsic′”). Combined with the systematic input (via adders 212 and 214), the sums (e.g., Systematic+Extrinsic, Systematic+Extrinsic'), which are referred to as intrinsic data (e.g., Intrinsic=Systematic+Extrinsic and Intrinsic′=Systematic+Extrinsic′), are respectively provided to decoder 208 and decoder 210. Similarly, the received Parity and Parity′ data are respectively provided to decoders 208, 210. While various techniques may be used, typically the data (e.g., Parity, Parity′, Intrinsic, Intrinsic′, Extrinsic, Extrinsic′, and Systematic) are stored (e.g., individually or in combinations such as Intrinsic′/Extrinsic, etc.) in one or more memories that are accessible by the respective decoders 208, 210 for retrieval.

Typically decoding systems that operate with a radix larger than two, such as the radix-4 decoding system illustrated, call for significant amount of parallel memory accesses to efficiently retrieve input data. Based upon how the data is stored (e.g., the type of memory used), accessing memory may be efficiently executed or cumbersome. For example, by storing consecutive data elements in a linear manner, the data can be accessed in parallel with relative ease. Typically the input data (e.g., Parity, Extrinsic/Intrinsic, Systematic) for the decoder 208 is stored in a linear manner and may be efficiently accessed. To improve access efficiency, each memory record (e.g., for a Parity entry) may be widened to store multiple consecutive entries. Parity′ data elements for the decoder 210 may also be stored in a consecutive, linear manner to allow for efficient access. Further, the other memory records may be widened (so each can store multiple data elements) to improve access efficiency. Decoder 210 accesses the Extrinsic/Intrinsic and Systematic data after being interleaved (by an interleaver 216). As such, the Extrinsic/Intrinsic and Systematic data may not be stored in a linear sequence and may not be easily accessible (compare to linearly stored data such as the Parity′ data). Further, while the records may be widened for storing multiple entries, the expanded records may not lend themselves to efficient access (due to the interleaving). So, rather than using a single operation to access (e.g., read) a sequence of consecutive Extrinsic/Intrinsic and Systematic data records, multiple operations (that may stall operations) may be needed to randomly access the data scattered throughout memory. Such additional access operations for decoder 210 may create a data processing bottleneck for the entire decoding system 200.

To reduce such bottlenecking for accessing data, one or more techniques may be used by the decoding system 200 and in particular, decoder 210. For example, interleaved Extrinsic/Intrinsic and Systematic data may be distributed to multiple memory banks that may be independently and simultaneously accessed in parallel. Further, by separating the interleaved data (with corresponding interleaved addresses) into two or more groups, each group may be stored in a dedicated memory bank to increase the probability of executing access operations in parallel absent of conflicts. For example, for a Radix-4 decoding system, memory banks may be established such that one bank is associated with even value addresses (of the Extrinsic/Intrinsic and Systematic data) and another memory bank is associated with odd valued addresses of the data. To direct access to the two memory banks and attempt to alleviate delays caused by a memory bank being accessed multiple times during one time instance, a memory access manager 218 receives the interleaved addresses (from the interleaver 216) and directs access to the corresponding Extrinsic/Intrinsic and Systematic data. In general, while the order of the addresses (provided to the memory access manager 218) may be scrambled by the interleaver 216, the number of addresses remains constant and the addresses are from a finite pool of addresses (e.g., an equivalent number of odd and even addresses during the decode). For example, one hundred addresses may be associated with the Extrinsic/Intrinsic and Systematic data and may be interleaved by the interleaver 216. After the interleaving operations, the same number of addresses (e.g., one hundred addresses) are still used to store the data. Further, since each address is associated with a unique numerical value, approximately half of the addresses have even numerical values and half have odd numerical values. Using the example, fifty (of the one hundred) address would be even numbered and the other fifty would be odd. As such, interleaving the finite pool of addresses does not produce a truly random sequence of addresses and the memory access manager 218 can direct multiple memory accesses by identifying the approximately half odd (as one memory bank) and half even addresses (as a second memory bank) included in a finite address pool. Once identified, both of the memory banks can be accessed in parallel during a single time instance and the memory access manager 218 may retrieve stored data (e.g., perform a read operation). The memory access manager 218 may also provide other functions, for example, retrieved data may be re-ordered to account for assigning the addresses into one of the two memory banks.

In this arrangement, once retrieved, the memory access manger 218 provides the interleaved Extrinsic/Intrinsic and Systematic data to the decoder 210 for performing decoding operations with the Parity′ data. Similarly, the Extrinsic/Intrinsic and Systematic data, absent interleaving, is provided to the decoder 208 to perform similar decoding operations. Once processed by the decoder 210, the decoded data is provided to a de-interleaver 220 that re-orders and stores the data into memory using another memory access manager 222. In some arrangements, the memory access manager 222 (or portions of the de-interleaver 220 architecture) may provide functions similar to memory access manager 218. For example, such similar operations and structures included in the memory access manager 222 may reduce bottlenecks caused by attempting to simultaneously execute multiple write operations to a portion of memory. In some arrangements, the functionality of the memory access manager 222 may be incorporated into the de-interleaver 220 or other portions of the decoding system 200. Similarly, the functionality of memory access manager 218 may be incorporated into other portions of the decoding system 200, such as the decoder 210. Once produced, each of the decoders 208, 210 provide extrinsic data (e.g., the de-interleaver 220 provides re-ordered extrinsic data from the decoder 210) to the respective adders 212, 214 to continue the recursive processing of the systematic data 202.

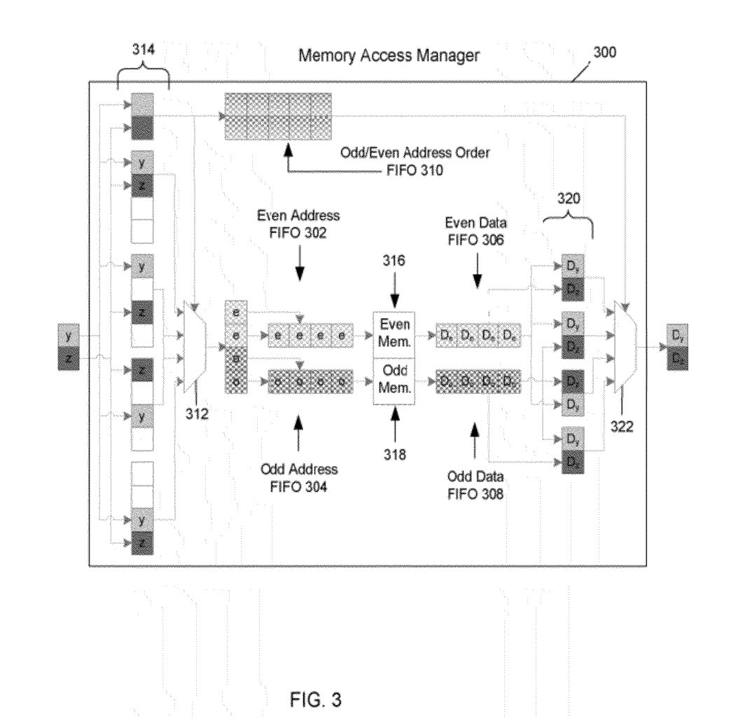

Referring to FIG. 3, a block diagram illustrates an exemplary memory access manager 300, which may provide the functions of memory access manager 218 (shown in FIG. 2), is capable of identifying and accessing multiple memory addresses (provided by an interleaver such as the interleaver 108) at one time instance. In general, the interleaved addresses are identified as being a member of one of a multiple of predefined groups (e.g., an even numbered address, an odd numbered address, etc.). Each address group may be associated with a distinct portion of memory that may be accessed in parallel with memory portions associated with the one or more other groups. As mentioned, one group may be defined the even numbered addresses provided to the memory access manager and another group may be defined as the odd numbered addresses. By accessing one or more odd and one or more even addresses in parallel, the memory access manager 300 may efficiently retrieve data and reduce the probability of attempting to access the same memory portion (e.g., a memory bank) multiple times during one time instance (and thereby potentially mitigate stall operations). In this particular illustration, addresses are associated with one of two distinct address groups (e.g., even and odd addresses), however in other arrangements additional address groups may be defined. For example, four, six or more address groups being defined that may be accessed in parallel. Such additional address groups may be needed for efficiently accessing data associated with other types of decoders such as Radix-8 decoders. Further, various techniques may be implemented to define types of addresses groups. For example, rather than using the least significant bit of an address to identify membership in a group (e.g., odd or even numbered addresses), additional bits (e.g., using the last two least significant bits to define four groups) or other types of information may be used establishing address group membership.

Once addresses are identified as being members of a particular address group, the group members are buffered to be appropriately accessed in parallel (e.g., parallel read operations). In this particular arrangement, a first-in first-out (FIFO) buffering technique is implemented by the memory access manager 300 to queue the addresses, however, one or more other buffering techniques may be implemented. The illustrated architecture includes five FIFOs, two of which (FIFOs 302 and 304) buffer the interleaved addresses based upon the address being even (e.g., buffered by FIFO 302) or odd (e.g., buffered by FIFO 304). Another pair of FIFOs (e.g., FIFOs 306 and 308) is used to buffer the data retrieved from corresponding even and odd addresses provided by the respective FIFOs 302 and 304. A fifth FIFO, FIFO 310, is used to buffer the least significant bits of the addresses provided by the interleaver. Along with indicating if the associated address is odd or even numbered, the least significant bits are also used to direct the addresses to the appropriate FIFO (via a multiplexer 312).

Demonstrating the processing provided by the memory access manger 300, for illustration, two addresses (labeled “y” and “z”) are received (from the interleaver) and are provided to a collection of registers 314. Along with providing the least significant bits to the FIFO 310 (for queuing the indication that the addresses are even or odd), the bits are provided to the multiplexer 312 for directing the addressees to the appropriate one of the FIFOs 302, 304 (depending if the address is even or odd). Typically FIFOs 302 and 304 are capable of having two address values simultaneously written to them. After progressing through the respective FIFO, a pair of even and odd addresses are used simultaneously to read data from the particular memory locations identified by each of the two addresses. For example, at one time instance, an even address (provided by FIFO 302) is used to retrieve data from a memory bank 316 (associated with even addresses) and an odd address (provided by FIFO 304) is used to simultaneously retrieve data from a memory back 318 (associated with odd addresses). Upon being received, the data (identified as “Dₑ” for data from address e and “Dₒ” for data from address o) is respectively stored in one of the FIFOs 306 and 308 and queued in preparation of being released from the memory access manager 300 to another processing stage. Additionally, since the order of the addresses was adjusted for efficiently accessing data (e.g., even addresses buffered together and odd addresses buffered together), the memory access manager 300 adjusts the order of the data (queued in the FIFOs 306 and 308) to the match the address sequence provided to the memory access manager 300 (e.g., provided from the interleaver). In this arrangement, upon exiting the FIFOs 306 and 308, the data is provided to a collection of registers 320 that serve as inputs to a multiplexer 322. Typically FIFOs 306 and 308 are capable of having two data values simultaneously read from them. To restore the order sequence, odd/even address indication data from the FIFO 310 directs the operation of the multiplexer 322 such that output data (e.g., D_{y} and D_{z}) complies with the order of the received addresses (e.g., y and z).

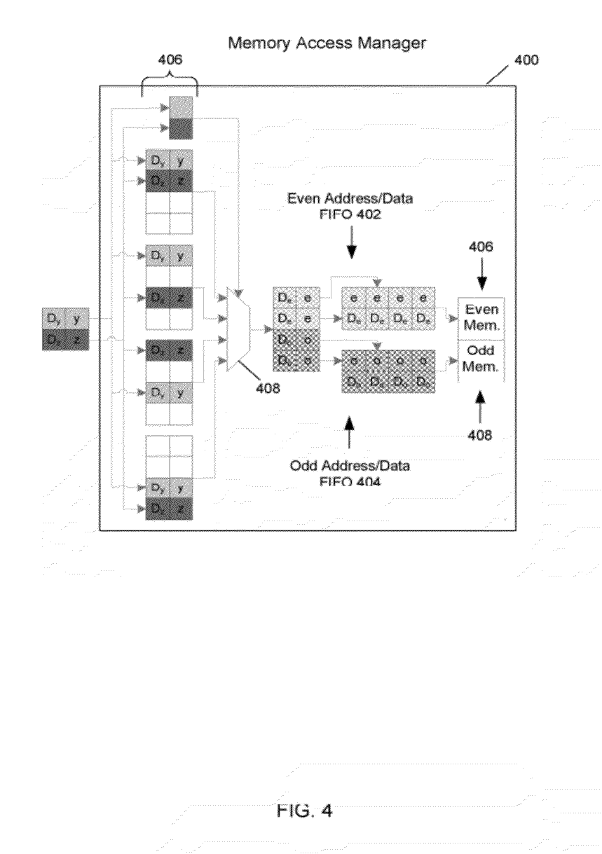

Referring to FIG. 4, similar to using address groups to efficiently read data, write operations may also be performed in parallel by using address groups. For example, an exemplary memory access manager 400, which may provide the functions of memory access manager 222 (shown in FIG. 2), may be used by a decoding system for writing data at particular decoding processes. For this particular architecture, one FIFO 402 is used for queuing even addresses and data and another FIFO 404 is used with odd addresses and data. Typically the FIFOs 402, 404 operate in a similar manner and may be similar to the FIFOs used in the memory access manager 300 (shown in FIG. 3) to read data from memory. Each of the FIFOs 402, 404 in this architecture buffer both addresses and data. For example, FIFO 402 stores both the even addresses along with corresponding data and FIFO 404 stores both the odd addresses and similarly corresponding data. To provide this storing capability, various types of architectures may be used by the memory access manager 400. For example, the FIFO 402 may be produced from a pair of FIFOs that share control logic. Similar or different techniques may be used to produce the FIFO 404 that is associated with odd addresses and associated data. FIFO parameters may be similar or shared among the FIFOs and may be similar to parameters of FIFOs of another memory access manager (e.g., the memory access manager 300). For example, the depth of each of the FIFOs 402, 404 may or may not be equivalent to the depths of the addresses associated with read operation FIFOs (e.g., FIFOs 302, 304).

To efficiently write data, such as extrinsic data provided by a decoder (e.g., the decoder 210), the addresses (labeled “y” and “z”) are provided to the memory access manager 400 along with the corresponding data (labeled “D_{y}” and D_{z}”). Similar to memory access manager 300, the addresses and data are received by a collection of registers 406 that provide an input to a multiplexer 408. A control signal (e.g., based upon the least significant bit of the address) is also provided to the multiplexer 408 to direct the addresses and data to appropriate one of the FIFOs 402, 404. Typically FIFOs 402 and 404 are capable of having two data values simultaneously written to them. Once buffered, the FIFOs 402, 404 are used to write data in parallel into appropriate memory banks by using the corresponding addresses. For example, at one time instance, data from FIFO 402 is written into the appropriate even numbered address of a memory bank 406 (associated with an even numbered address group) and data from FIFO 404 is written into the appropriate odd numbered address of a memory bank 408 (associated with an odd numbered address group). Also similar to the FIFOs of memory access manager 300, if one or both of the FIFOs 402 and 404 reach storage capacity (e.g., fill up), operations are stalled until space becomes available. By providing such parallel writing capabilities, operational efficiency of the memory access manager 400 increases while the probability of experiencing a data bottleneck may be reduced.

Typically each of the FIFOs included in the memory access managers 300, 400 share similar characteristics, however, in some arrangements different FIFOs may be implemented. FIFO length is one parameter that may be adjusted for performance, for example, longer FIFO lengths increase the amount of addresses and data that may be buffered. Along with increasing efficiency, the uniform distribution of odd and even addresses may be more pronounced in FIFOs with longer lengths. However, while performance may be directly proportional to FIFO length, constraints such as physical size allowances, energy budgets, etc. may limit the chosen length of the FIFOs. As such, FIFO length may be determined by balancing throughput performance and these constraints (and other possible factors). Various metrics may be used to strike such a balance, for example, measuring and quantifying the average memory accesses per clock cycle. For a Radix-4 decoding system, optimum performance may be defined as two memory accesses per clock cycle (or ½ cycles per bit). To approach this performance level, the length of each FIFO can be increased. As such, by measuring performance as a function of FIFO length, an appropriate balance may be achieved.

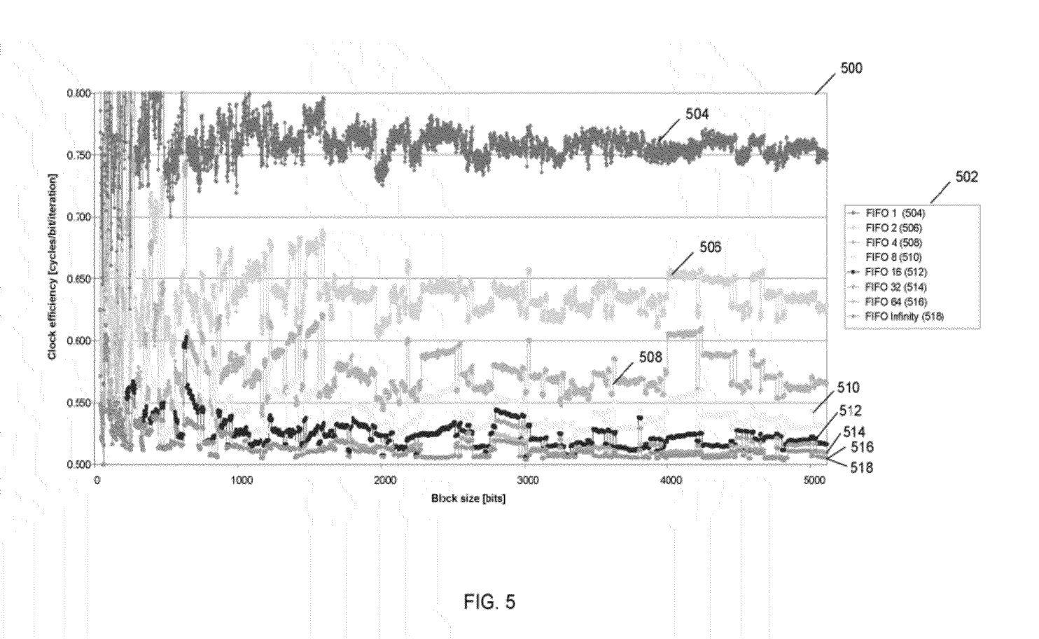

Referring to FIG. 5, a chart 500 represents a performance measure, clock efficiency, as a function of data block size. The performance is calculated for a series of FIFO lengths as indicated by a chart key 502. In particular, FIFO length ranges from one to sixty-four (using a step of 2^{N}, where N increments from zero to six). As illustrated by trace 504, which corresponds to a FIFO length of one, performance is centered about an approximate ceiling of 0.75. As the FIFO length is increased, the corresponding traces step toward the theoretical limit of 0.50. For example, trace 506 corresponds to a FIFO length of two and traces 508, 510, 512, 514, 516 and 518 respectively correspond to lengths of four, eight, sixteen, thirty-two and sixty-four. Additionally, a trace 520 represents the performance of a FIFO of infinite length, which is closest to the 0.5 limit. While additional lengths may be selected for defining one or more FIFOs of a memory access manager, for some applications, a FIFO length of sixteen may be considered particularly useful.

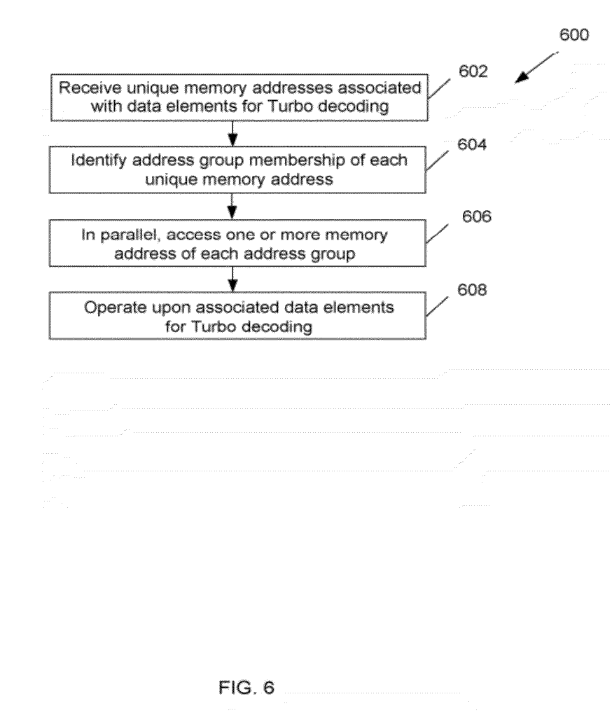

Referring to FIG. 6, a flowchart 600 represents some of the operations of a memory access manager such as the mangers 300 and 400 (respectively shown in FIGS. 3 and 4). Such a manager may be implemented in one or more types of hardware architectures such as a processor based architecture or other type of design. In some processor based architectures, the memory access manager may be executed on a single processor or distributed across multiple processors. Various types of circuitry (e.g., combinational logic, sequential logic, etc.) and computing devices (e.g., a computer system) may also be used individually or in combination to execute the operations of the memory access manager. For example, in a processor-based decoding system design, instructions may be executed by a processor (e.g., a microprocessor) to provide the operations of the memory access manager. Such instructions may be stored in a storage device (e.g., hard drive, CD-ROM, etc.) and provided to the processor (or multiple processors) for execution.

Operations of the memory access manager include receiving 602 unique memory addresses that are associated with data elements for Turbo decoding (e.g., provided to a Radix-4 Turbo decoder). For example, the addresses may be provided to the memory access manager for writing associated data elements to appropriate data banks or reading data elements from data banks. Operations of the memory access manager also include identifying 604, for each unique memory address, one address group (from multiple address groups) to which the address is a member. For example, the least significant bit of each address may be used to identify the address as belonging to an address group associated with even numbered addresses or another address group that is associated with odd numbered addresses. Once identified, the addresses may be buffered (into dedicated FIFOs) based upon the address group membership. Operations of the memory access manager also include, accessing 606 one or more memory addresses from each address group in parallel. For example, one (or more) addresses included in even numbered address group may be accessed (for read or write operations) during the same instance that one (or more) addresses included in the odd numbered address group are accessed. Upon accessing the addresses in parallel, operations may include operating 608 upon the associated data elements for Turbo decoding of the elements. For example, along with reading and writing data elements associated with the memory addresses, operations may include re-ordering the sequence of the data elements.

As mentioned above, in some decoding system designs may be processor based. As such, to perform the operations described in the flow chart 600, the memory access manager and optionally with other portions of the decoder system may perform any of the computer-implemented methods described previously, according to one implementation. For example, the decoding system may include a computing device (e.g., a computer system) for executing instructions associated with the decoding data elements. The computing device may include a processor, a memory, a storage device, and an input/output device. Each of the components may be interconnected using a system bus or other similar structure. The processor may be capable of processing instructions for execution within the computing device. In one implementation, the processor is a single-threaded processor. In another implementation, the processor is a multi-threaded processor. The processor is capable of processing instructions stored in the memory or on the storage device to display graphical information for a user interface on the input/output device.

The memory stores information within the computing device. In one implementation, the memory is a computer-readable medium. In one implementation, the memory is a volatile memory unit. In another implementation, the memory is a non-volatile memory unit.

The storage device is capable of providing mass storage for the computing device. In one implementation, the storage device is a computer-readable medium. In various different implementations, the storage device may be a floppy disk device, a hard disk device, an optical disk device, or a tape device.

The input/output device provides input/output operations for the computing device. In one implementation, the input/output device includes a keyboard and/or pointing device. In another implementation, the input/output device includes a display unit for displaying graphical user interfaces.

The features described (e.g., the decoding system 200) can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

Other embodiments are within the scope of the following claims. The techniques described herein can be performed in a different order and still achieve desirable results.

What is claimed is:

1. A method of accessing a memory for data decoding, comprising:
receiving a sequence of unique memory addresses associated with concatenated, convolutionally encoded data elements;
identifying each of the unique memory addresses as being included in one group of a plurality of address groups, wherein each address group substantially includes an equivalent number of unique addresses; and
in parallel, accessing at least one memory address associated with each group of the plurality of address groups to operate upon the respective concatenated, convolutionally encoded data elements associated with each of the unique memory addresses being accessed.

2. The method of claim 1, wherein operating upon the respective concatenated, convolutionally encoded data elements includes reading the data elements from the unique memory addresses being accessed.

3. The method of claim 1, wherein operating upon the respective concatenated, convolutionally encoded data elements includes writing the data elements to the appropriate unique memory addresses.

4. The method of claim 1, further comprising:
ordering the data elements based upon the address group identifications of the corresponding unique memory addresses.

5. The method of claim 1, wherein the received unique memory addresses associated with the concatenated, convolutionally encoded data elements are interleaved.

6. The method of claim 1, wherein receiving unique memory addresses includes entering one unique memory address into a first buffer and entering another unique memory address into a second buffer.

7. The method of claim 6, wherein the first buffer and second buffer have equivalent lengths.

8. The method of claim 6, wherein the first buffer and the second buffer are configured to store sixteen unique memory addresses.

9. A computing device comprising:
a decoder for receiving a sequence of unique memory addresses associated with concatenated, convolutionally encoded data elements, the decoder is configured to identify each of the unique memory addresses as being included in one group of a plurality of address groups, wherein each address group substantially includes an equivalent number of unique addresses, the decoder is further configured to, in parallel, access at least one memory address associated with each group of the plurality of address groups to operate upon the respective concatenated, convolutionally encoded data elements associated with each of the unique memory addresses being accessed.

10. The computing device of claim 9, wherein to operate upon the respective concatenated, convolutionally encoded data elements, the decoder is configured to read the data elements from the unique memory addresses being accessed.

11. The computing device of claim 9, wherein to operate upon the respective concatenated, convolutionally encoded data elements, the decoder is configured to write the data elements to the appropriate unique memory addresses.

12. The computing device of claim 9, wherein the decoder is further configured to order the data elements based upon the address group identifications of the corresponding unique memory addresses.

13. The computing device of claim 9, wherein the received unique memory addresses associated with the concatenated, convolutionally encoded data elements are interleaved.

14. The computing device of claim 9, wherein the decoder includes a first buffer for entering one unique memory address and a second buffer for entering another unique memory address.

15. The computing device of claim 14, wherein the first buffer and second buffer have equivalent lengths.

16. The computing device of claim 14, wherein the first buffer and the second buffer are configured to store sixteen unique memory addresses.

17. A computer program product tangibly embodied in an information carrier and comprising instructions that when executed by a processor perform a method comprising:
receiving a sequence of unique memory addresses associated with concatenated, convolutionally encoded data elements;
identifying each of the unique memory addresses as being included in one group of a plurality of address groups, wherein each address group substantially includes an equivalent number of unique addresses; and
in parallel, accessing at least one memory address associated with each group of the plurality of address groups to operate upon the respective concatenated, convolutionally encoded data elements associated with each of the unique memory addresses being accessed.

18. The computer program product of claim 17, further comprising instructions that when executed by the processor perform a method comprising:
ordering the data elements based upon the address group identifications of the corresponding unique memory addresses.

19. The computer program product of claim 17, wherein the received unique memory addresses associated with the concatenated, convolutionally encoded data elements are interleaved.

20. The computer program product of claim 17, wherein receiving unique memory addresses includes entering one unique memory address into a first buffer and entering another unique memory address into a second buffer.
